(19) United States
(12) Patent Application Publication
(10) Pub. No.: US 2022/0253556 A1
(43) Pub. Date: Aug. 11, 2022

(54) INFORMATION PROCESSING DEVICE, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Kengo TOKUCHI, Kanagawa (JP); Yuta NAKAMORI, Tokyo (JP)

(73) Assignee: FUJIFILM Business Innovation Corp., Tokyo (JP)

(21) Appl. No.: 17/383,676

(22) Filed: Jul. 23, 2021

(30) Foreign Application Priority Data
Feb. 8, 2021 (JP) 2021-018469

(51) Int. Cl. G06F 21/62; G06F 3/06

(52) U.S. Cl. CPC G06F 21/6254; G06F 3/067; G06F 3/0646; G06F 3/062

(57) ABSTRACT

An information processing device includes a processor configured to anonymize classification information associated with data and used to classify the data in a case where the data is transferred to another storage location.

### CROSS-REFERENCE TO RELATED APPLICATIONS

This application is based on and claims priority under 35 USC 119 from Japanese Patent Application No. 2021-018469 filed Feb. 8, 2021.

### BACKGROUND

### (i) Technical Field

The present disclosure relates to an information processing device, an information processing method, and a non-transitory computer readable medium.

### (ii) Related Art

Japanese Unexamined Patent Application Publication No. 11-328218 describes a device that extracts content attribute information from a document file, performs an attribute structure normalization process on the extracted content attribute information, and performs a character format normalization process on the content attribute information of normalized structure.

Japanese Unexamined Patent Application Publication No. 2004-127000 describes a device that automatically acquires attribute values from a linked database by specifying a character string applied to a tag of a structured document.

Japanese Unexamined Patent Application Publication No. 2017-182201 describes a relay server that transmits a user message from a first social networking service (SNS) server, determines whether or not the message is a processing request with respect to a registration site, and on the basis of a keyword table storing keywords that the registration site is capable of processing, generates a processing request with respect to the registration site from the determined message, and transmits response information to the first SNS server or a second SNS server on the basis of response information from the site that has received the processing request.

Japanese Unexamined Patent Application Publication No. 2014-157390 describes a device that classifies content data on the basis of attributes, and selects content data suited to each classification item to generate a display image displaying a list.

### SUMMARY

Aspects of non-limiting embodiments of the present disclosure relate to keeping an unintended person from knowing classification information associated with data and used to classify the data.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to anonymize classification information associated with data and used to classify the data in a case where the data is transferred to another storage location.

### BRIEF DESCRIPTION OF THE DRAWINGS

An exemplary embodiment of the present disclosure will be described in detail based on the following figures, wherein:

FIG. 1 is a block diagram illustrating a configuration of an information processing system according to an exemplary embodiment;

FIG. 2 is a block diagram illustrating a configuration of a server;

FIG. 3 is a block diagram illustrating a configuration of a terminal device;

FIG. 4 is a diagram illustrating classification information;

FIG. 5 is a diagram illustrating classification information;

FIG. 6 is a block diagram illustrating a server and terminal devices;

FIG. 7 is a diagram illustrating folders;

FIG. 8 is a diagram illustrating folders; and

FIG. 9 is a block diagram illustrating a server and terminal devices.

### DETAILED DESCRIPTION

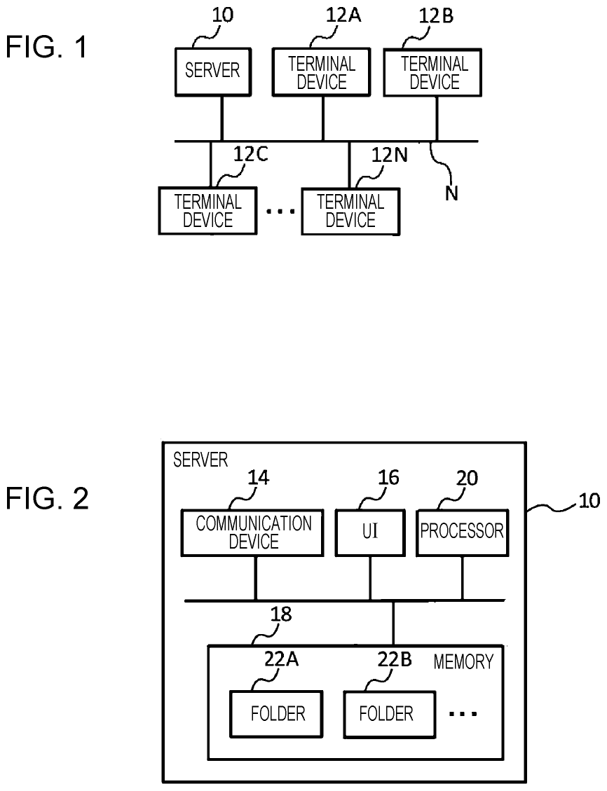

An information processing system according to the exemplary embodiment will be described with reference to FIG. 1. FIG. 1 illustrates an example of the configuration of the information processing system according to the exemplary embodiment.

The information processing system according to the exemplary embodiment includes a server 10 and N terminal devices (where N is an integer equal to or greater than 1), for example. In the example illustrated in FIG. 1, the information processing system according to the exemplary embodiment includes terminal devices 12A, 12B, 12C, . . . , 12N. The number of terminal devices illustrated in FIG. 1 is merely an example, and it is sufficient for the information processing system according to the exemplary embodiment to include one or multiple terminal devices. Hereinafter, the terminal devices 12A, 12B, 12C, . . . , 12N will be referred to as the “terminal device(s) 12” when not being individually distinguished. The information processing system according to the exemplary embodiment may also include other devices besides the server 10 and the terminal devices 12.

The server 10 and the terminal devices 12 have a function of communicating with other devices. The communication may be wired communication using a cable, or wireless communication. In other words, each device may transmit and receive information through a physical connection to other devices using a cable, or transmit and receive information through wireless communication. The wireless communication is a technology such as short-range wireless communication or Wi-Fi (registered trademark) may be used, for example. The short-range wireless communication may be a technology such as Bluetooth (registered trademark), radio-frequency identifier (RFID), or NFC, for example. For example, each device may communicate with other devices through a communication channel N such as a local area network (LAN) or the Internet.

The server 10 provides an online service through the communication channel N. A user is able to use the online service using one of the terminal devices 12.

For example, the online service is a service that provides online storage, a service that provides an online conference, a service that provides content online, a service that provides an online game, a service that provides online shopping, a social networking service (SNS), or a combination of at least two of the above. An online conference may also be referred to as a web conference, a remote conference, or a video conference. The content may be entertainment (such as a concert, a theatrical performance, a movie, a video, or music, for example), sports, or esports, for example. For example, a video distribution service and a music distribution service are examples of the service that provides content online. The user is able to enjoy entertainment, watch sports or esports, and the like online.

The online service may be a service that uses a virtual space or a service that does not use a virtual space. A virtual space is a concept used in contrast to a real space, and refers to a virtual space achieved by a computer, a virtual space formed on a network such as the Internet, a virtual space achieved by virtual reality (VR) technology, or cyberspace, for example. For example, a virtual three-dimensional space or two-dimensional space corresponds to an example of a virtual space.

The server 10 may receive and store data transmitted to the server 10 from the terminal devices 12, transmit data transmitted to the server 10 from one terminal device 12 to another terminal device 12, or transmit data stored in the server 10 to the terminal devices 12. The server 10 may also be a file server, and may include a function of constructing a database.

Each terminal device 12 is a personal computer (hereinafter referred to as a “PC”), a tablet PC, a smartphone, a wearable device (such as augmented reality (AR) glasses, virtual reality (VR) glasses, mixed reality (MR) glasses, or a bearable device), or a mobile phone, for example.

In the exemplary embodiment, when data is transferred to another storage location, classification information associated with the data and used to classify the data is anonymized.

The data is not particularly limited, and is for example image data, video data, audio data (such as speech data or music data), text data (such as a message), document data, drawing data, biometric-related data (for example, various data obtained from a living thing), other data perceived by any of the five senses (such as tactile data, gustatory data, or olfactory data), control data for controlling equipment, or a combination of at least two of the above. Obviously, the above are merely examples, and the data used in the exemplary embodiment may be a type of data other than the data described here. Furthermore, the format of the data is not particularly limited. Programs may also be included in the conceptual category of data.

The classification information is not particularly limited insofar as the information may be used to classify data. For example, the classification information is information indicating the creation date and time of the data, information indicating the modification date and time of the data, information indicating the type of the data, information indicating the volume of the data, information indicating the name of the data, information indicating the date and time when the data was accessed, information indicating a genre, category, or field of content expressed by the data, information indicating attributes of a creator of the data, information indicating a place (such as a country or geographical area) where the data was created, or a combination of at least two of the above. The information indicating attributes of the creator may be, for example, information for identifying the creator (such as a name, a user ID, or account information), information indicating the gender of the creator, information indicating the age of the creator, information indicating the address or whereabouts of the creator, information indicating the creator's place of origin (such as country or geographical area), information indicating physical characteristics of the creator, information indicating the creator's hobbies and interests, information indicating the creator's thoughts, information indicating the creator's preferences, or a combination of at least two of the above. The classification information may also be metadata or tag information attached to the data. The classification information may be used to search the data. By using the classification information, the data may be classified or searched.

The classification information is attached to the data, for example. In the case where the data is transferred, the classification information is attached to the data and transferred with the data as the data is transferred.

Transferring data means moving the data from a storage location where the data is stored to a different storage location, for example. The different storage location treated as the transfer destination may be a storage location formed in the same device as the storage location treated as the transfer source where the data was originally stored, or a storage location formed in a different device. Transmitting data to a storage location formed in a different device (such as the server 10 or another terminal device 12) by wired or wireless communication is also included in the conceptual category of transferring data. For example, actions such as transmitting data to online storage, posting data to an SNS, using an SNS to transmit data to a communication peer, and using email to transmit data to a communication peer are examples of transferring data. Obviously, data may also be transferred by methods other than the above. Data may be copied and the data generated by copying may be transferred, or data may be transferred without being copied. Data may be transferred while remaining stored in the source storage location, or data may be transferred without remaining stored in the source storage location.

The storage location is a storage area, folder, or directory where data is stored, for example. The storage location is formed in the server 10, the terminal device 12, or another device.

Anonymization includes removing or encrypting some or all of the classification information, replacing information with different information, hiding information, or at least two of the above processes. Removed information may be stored in the server 10, the terminal device 12, or the like. The type of encryption is not particularly limited, and known technology may be used. Hiding refers to keeping some or all of the classification information from being displayed. The process of replacing information with different information replaces the original information with different information such that tracing back to the original information is substantially unfeasible. The information to be replaced includes personally identifiable sign information (such as a name, for example). The replacing information replaces the original information with information that is unrelated to the original information, such as information belonging to a field distant from the original information, or information whose meaning is not easily understood by humans (such as a mere list of symbols, a random number, or a random character string).

Hereinafter, FIG. 2 will be referenced to describe a hardware configuration of the server 10. FIG. 2 illustrates an example of a hardware configuration of the server 10.

The server 10 includes a communication device 14, a user interface (UI) 16, a memory 18, and a processor 20, for example.

The communication device 14 is a communication interface including components such as a communication chip and a communication circuit, and has a function of transmitting information to another device and a function of receiving information from another device. The communication device 14 may have a wireless communication function, and may also have a wired communication function. The communication device 14 may communicate with another device by using short-range wireless communication for example, or communicate with another device through the communication channel N.

The UI 16 is a user interface, and includes at least one of a display or an input device. The display is a liquid crystal display (LCD), an electroluminescence (OLED) display, or the like. The input device is a device such as a keyboard, a mouse, input keys, or a control panel. The UI 16 may also be a UI such as a touch panel combining a display with an input device.

The memory 18 is a device that establishes one or multiple storage areas that store data. For example, the memory 18 is a hard disk drive, any of various types of memory (such as RAM, DRAM, or ROM, for example), another type of storage device (such as an optical disc, for example), or a combination of the above. One or multiple memories 18 are included in each server 10.

The processor 20 is configured to control the operation of each unit of each server 10. The processor 20 may include a memory. For example, the processor 20 provides an online service to users.

One or multiple folders are formed in the memory 18. In the example illustrated in FIG. 2, folders 22A, 22B, and so on are formed. The folders formed in the memory 18 are examples of a storage location. All or part of the memory 18 may also be an example of a storage location. Note that folders do not have to be formed in the memory 18.

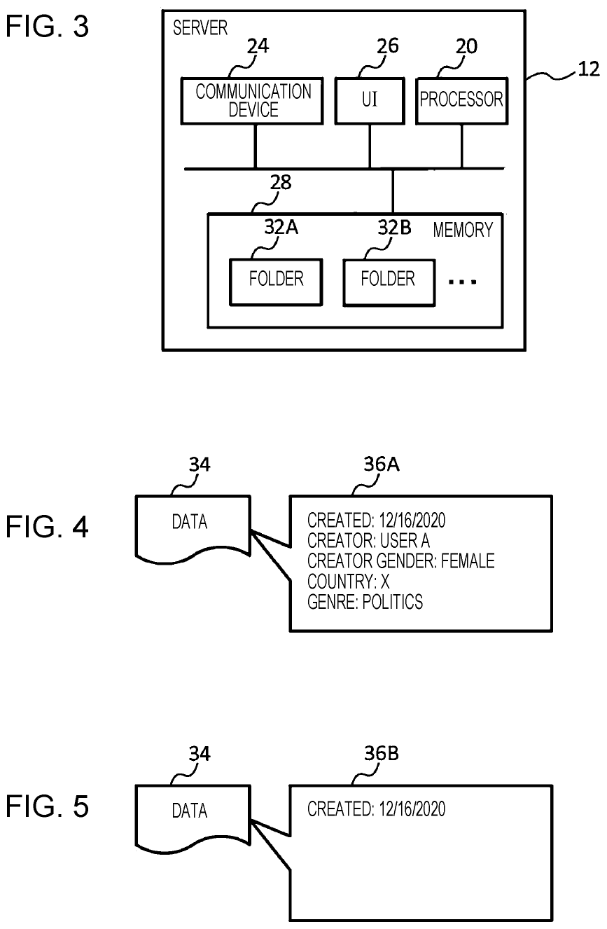

Hereinafter, FIG. 3 will be referenced to describe a hardware configuration of each terminal device 12. FIG. 3 illustrates an example of the hardware configuration of each terminal device 12.

The terminal device 12 includes a communication device 24, a user interface (UI) 26, a memory 28, and a processor 30, for example.

The communication device 24 is a communication interface including components such as a communication chip and a communication circuit, and has a function of transmitting information to another device and a function of receiving information transmitted from another device. The communication device 24 may have a wireless communication function, and may also have a wired communication function. The communication device 24 may communicate with another device by using short-range wireless communication for example, or communicate with another device through the communication channel N.

The UI 26 is a user interface, and includes at least one of a display or an input device. The display is a liquid crystal display (LCD), an electroluminescence (OLED) display, or the like. The input device is a device such as a keyboard, a mouse, input keys, or a control panel. The UI 26 may also be a UI such as a touch panel combining a display with an input device. The UI 26 may also include a microphone and a speaker. Additionally, the terminal device 12 may also include an imaging device such as a camera.

The memory 28 is a device that establishes one or multiple storage areas that store data. For example, the memory 28 is a hard disk drive, any of various types of memory (such as RAM, DRAM, and ROM, for example), another type of storage device (such as an optical disc, for example), or a combination of the above. One or multiple memories 28 are included in the terminal device 12.

The processor 30 is configured to control the operation of each component of the terminal device 12. The processor 30 may include a memory.

One or multiple folders are formed in the memory 28. In the example illustrated in FIG. 3, folders 32A, 32B, and so on are formed. The folders formed in the memory 28 are examples of a storage location. All or part of the memory 28 may also be an example of a storage location. Note that folders do not have to be formed in the memory 28.

Hereinafter, Examples of the exemplary embodiment will be described. The processor 20 of the server 10 or the processor 30 of the terminal device 12 may execute the processes according to each Example, or the processor 20 and the processor 30 may cooperate to execute the processes according to each Example. One portion of the processes may be executed by the processor 20 while another portion of the processes may be executed by the processor 30. Note that the server 10, the terminal device(s) 12, or a combination of both corresponds to one example of an information processing device according to the exemplary embodiment. In the following, as an example, the processor 30 of the terminal device 12 executes the processes according to each Example, but obviously some or all of the processes according to each Example may also be executed by the processor 20 of the server 10.

FIGS. 4 and 5 will be referenced to describe an example of classification information. FIG. 4 illustrates an example of classification information before anonymization, and FIG. 5 illustrates an example of classification information in an anonymized state.

Classification information 36A of data 34 is associated with the data 34. In the example illustrated in FIG. 4, the classification information 36A includes information such as information indicating the creation date of the data 34, information for identifying the creator (for example, information indicating the name of the creator), information indicating the gender of the creator, information indicating the country where the data 34 was created, and information indicating a genre of the content expressed by the data 34. The classification information 36 illustrated in FIG. 4 is merely an example, and other information may be included in the classification information 36A, and some or all of the information illustrated in FIG. 4 does not have to be included in the classification information 36A. The information included in the classification information 36A may be specified by the creator of the data 34, may be predetermined, or may be specified by an administrator of the online service provided by the server 10.

As an example, the data 34 is stored in the folder 32A formed in the memory 28 of the terminal device 12A used by a user A. When transferring the data 34 from the folder 32A to another storage location, the processor 30 of the terminal device 12A anonymizes some or all of the classification information 36A.

FIG. 5 illustrates classification information 36B in the anonymized state. Here, as an example, anonymization is achieved by removing a portion of the classification information. The items to be removed are predetermined, and the information corresponding to the items is removed from the classification information. In the example illustrated in FIG. 5, information other than the information indicating the creation date (for example, the information indicating the creator, the gender of the creator, the country of creation, and the genre) has been removed. For example, information which could be used to specify the creator of the data 34 (for example, information for identifying the creator, such as the name and gender of the creator) and information which could be used to specify the content of the data 34 (for example, information indicating the genre or field) are the targets of anonymization. Obviously, it is also possible to remove only a portion of the above information, and it is also possible to remove all of the classification information 36A. The information to be removed (that is, the information to be anonymized) may be specified by the creator of the data 34, may be predetermined, or may be specified by an administrator of the online service provided by the server 10. Here, anonymization is achieved by removing information, but some or all of the classification information 36A may also be encrypted or kept from being displayed on the destination device to which the data 34 is transferred. For example, the information other than the information indicating the creation date may be encrypted, or the information other than the information indicating the creation date may not be displayed on the destination device.

For example, in the case where the user A uses the terminal device 12A to give an instruction to transfer the data 34, the processor 30 of the terminal device 12A anonymizes the classification information 36A and causes the data 34 associated with classification information 36B in an anonymized state to be transferred to another storage location treated as the destination storage location. The classification information 36B is attached to the data 34 to be transferred, and is transferred to the other storage location together with the data 34. The classification information 36A is not associated with the data 34 to be transferred, and is not transferred to the other storage location. In other words, the data 34 and the classification information 36B illustrated in FIG. 5 are transferred to the other storage location treated as the destination, but the classification information 36A is not transferred to the other storage location.

Examples of transferring the data 34 include posting the data 34 to an SNS, sending the data 34 by email, transmitting the data 34 to online storage, posting the data 34 to a video distribution site or a music distribution site, and posting the data 34 to a message board on the Internet. Obviously, the data 34 may also be transferred by methods other than the above.

Note that the anonymization may be performed by the processor 30 of the terminal device 12A, by the processor 20 of the server 10, or by a processor of the destination device to which the data 34 is transferred (for example, the server 10 or another terminal device 12 other than the terminal device 12A). A portion of the anonymization may be performed by the processor 30 of the terminal device 12A and another portion of the anonymization may be performed by a device other than the terminal device 12A.

Hereinafter, Examples of the exemplary embodiment will be described.

### Example 1

The other storage location treated as the destination storage location of the data 34 is in a different device from the terminal device 12A where the data 34 is stored. When transferring the data 34 to a different device from the terminal device 12A, the processor 30 of the terminal device 12A anonymizes the classification information 36A to generate the classification information 36B, and transfers the data 34 associated with the classification information 36B to the different device. The classification information 36B is attached to the data 34 and is also transferred to the other device. The classification information 36A is not transferred to the other device.

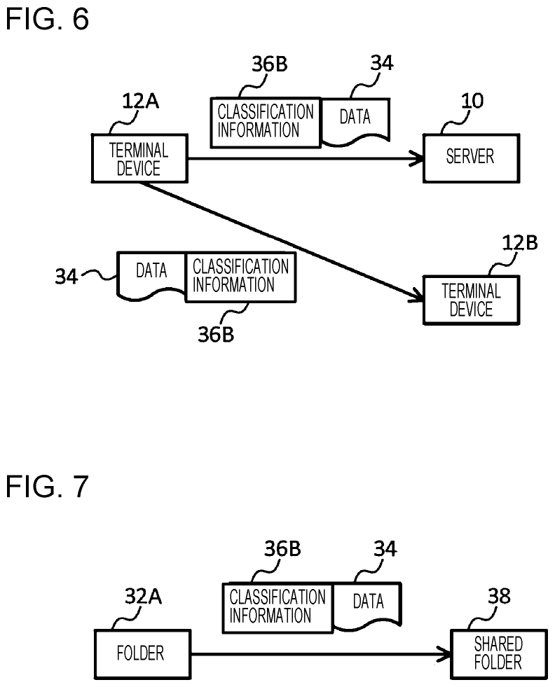

FIG. 6 will be referenced to describe an example of a case where the data 34 stored in the terminal device 12A is transmitted to a device other than the terminal device 12A. FIG. 6 illustrates the server 10 and the terminal devices 12A and 12B.

For example, in the case where the user A uses the terminal device 12A to give an instruction to transmit the data 34 to the server 10, the processor 30 of the terminal device 12A anonymizes the classification information 36A to generate the classification information 36B, and transmits the data 34 associated with the classification information 36B to the server 10. The non-anonymized classification information 36A is not transmitted to the server 10. For example, in the case where the server 10 provides a service such as an SNS, online storage, a video distribution service, or a music distribution service, the user A may conceivably transmit the data 34 from the terminal device 12A to the server 10. Note that the classification information 36A may also be anonymized by the processor 20 of the server 10 rather than by the processor 30 of the terminal device 12A.

Also, in the case where the user A uses the terminal device 12A to give an instruction to transmit the data 34 to the terminal device 12B, the processor 30 of the terminal device 12A anonymizes the classification information 36A and transmits the data 34 associated with the classification information 36B to the terminal device 12B. The non-anonymized classification information 36A is not transmitted to the terminal device 12B. Note that the classification information 36A may also be anonymized by the processor 30 of the terminal device 12B rather than by the processor 30 of the terminal device 12A.

The data 34 may be stored in the source storage location (that is, the folder 32A formed in the memory 28 of the terminal device 12A) even if the data 34 is transmitted to a device other than the terminal device 12A, or the data 34 may be transmitted to a device other than the terminal device 12A without being stored in the source storage location. For example, the data 34 may be copied, and the generated copy of the data 34 is transferred to the destination storage location while the original copy of the data 34 remains stored in the source storage location. In the case where the data 34 is stored in the source storage location (that is, the folder 32A formed in the memory 28 of the terminal device 12A) even if the data 34 is transmitted to a device other than the terminal device 12A, the non-anonymized classification information 36A is associated with the data 34 stored in the source storage location. With this arrangement, the non-anonymized classification information 36A may be referenced and used in the terminal device 12A.

### Example 2

In Example 2, the other storage location treated as the destination storage location of the data 34 is a storage location accessible by multiple users. The storage location accessible by multiple users is a shared folder, for example.

FIG. 7 will be referenced to describe an example of a case where the data 34 stored in the folder 32A is transferred to a shared folder 38. FIG. 7 illustrates the folder 32A and the shared folder 38. The folder 32A is a folder formed in the memory 28 of the terminal device 12A. The shared folder 38 may be a folder formed in the memory 28 of the terminal device 12A or a folder formed in another device other than the terminal device 12A.

In Example 2, the folder 32A is a personal folder used by the user A. The personal folder is associated with the account information of the user allowed to access the folder, and the folder is accessible by using the account information of the corresponding user. For example, the folder 32A is associated with the account information of the user A, and the folder 32A is accessible by using the account information of the user A. For example, if the account of the user A is used to log in to the terminal device 12A, access to the folder 32A is granted. In the case where access to the folder 32A is granted, data stored in the folder 32A is usable.

The shared folder 38 is a folder accessible by multiple users. For example, the shared folder 38 may be accessible by any user, without demanding account information for accessing the folder. Obviously, account information prohibited from accessing the shared folder 38 may be set, and access to the shared folder 38 using the account information may be denied.

For example, the shared folder 38 is formed in the memory 28 of the terminal device 12A, and each user (for example, the user A and another user other than the user A) is allowed to access the shared folder 38 without using specific account information to log in to the terminal device 12A. In other words, the shared folder 38 is also accessible by users other than the user A.

In the case where the user A uses the terminal device 12A to give an instruction to transfer the data 34 stored in the personal folder 32A to the shared folder 38, the processor 30 of the terminal device 12A anonymizes the classification information 36A and transfers the data 34 associated with the classification information 36B to the shared folder 38. The classification information 36A is not associated with the data 34 to be transferred. The data 34 is stored in the shared folder 38.

The data 34 may be transferred to the shared folder 38 while remaining stored in the folder 32A treated as the source storage location, or the data 34 may be transferred to the shared folder 38 without remaining stored in the folder 32A. The classification information 36A is associated with the data 34 stored in the folder 32A.

Note that the folder 32A and the shared folder 38 may also be formed in another device other than the terminal device 12A (such as the server 10 or another terminal device 12 other than the terminal device 12A). For example, the folder 32A and the shared folder 38 are formed in online storage provided by the server 10. Even in the above case, the folder 32A is accessible by the user A only, while the shared folder 38 is accessible by the user A and users other than the user A. In the case of transferring the data 34 stored in the folder 32A to the shared folder 38, the classification information 36A is anonymized, and the data 34 associated with the classification information 36B is transferred from the folder 32A to the shared folder 38.

Note that in the case where the shared folder 38 is formed in another device other than the terminal device 12A (such as the server 10 or another terminal device 12 other than the terminal device 12A), the classification information 36A may be anonymized by the other device.

In Examples 1 and 2 described above, the classification information 36A does not have to be anonymized when transferring the data 34 from a personal storage location used by the user A to a different personal storage location used by the user A.

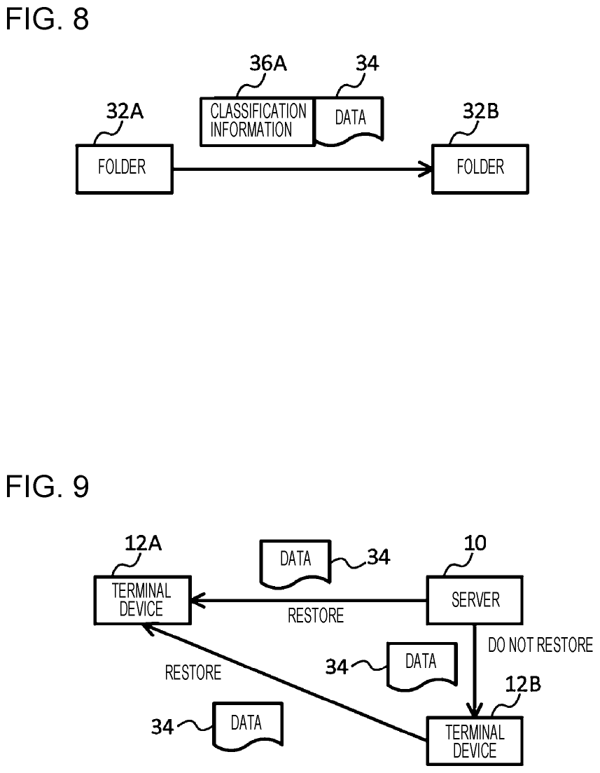

FIGS. 7 and 8 will be referenced to describe the above process. FIG. 8 illustrates the folders 32A and 32B. The folders 32A and 32B are folders formed in the memory 28 of the terminal device 12A. The shared folder 38 illustrated in FIG. 7 may be a folder formed in the memory 28 of the terminal device 12A or a folder formed in another device other than the terminal device 12A.

The folders 32A and 32B are personal folders used by the user A. For example, the folders 32A and 32B are associated with the account information of the user A, and the folders 32A and 32B are accessible by using the account information of the user A. For example, if the account of the user A is used to log in to the terminal device 12A, access to the folders 32A and 32B is granted.

As illustrated in FIG. 8, in the case of transferring the data 34 stored in the personal folder 32A of the user A to the other personal folder 32B of the user A, the processor 30 of the terminal device 12A transfers the data 34 associated with the classification information 36A to the folder 32B, without anonymizing the classification information 36A.

As illustrated in FIG. 7, in the case of transferring the data 34 stored in the personal folder 32A of the user A to a folder other than a personal folder of the user A (for example, the shared folder 38), the processor 30 of the terminal device 12A anonymizes the classification information 36A and transfers the data 34 associated with the classification information 36B to the shared folder 38.

Note that the folders 32A and 32B may also be formed in another device other than the terminal device 12A (such as the server 10 or another terminal device 12 other than the terminal device 12A). For example, the folders 32A and 32B are formed in online storage provided by the server 10. Even in this case, the folders 32A and 32B are accessible only by the user A. In the case of transferring the data 34 stored in the folder 32A to the folder 32B, the classification information 36A is not anonymized, and the data 34 associated with the classification information 36A is transferred from the folder 32A to the folder 32B.

### Example 3

In Example 3, when data is transferred to another storage location and then the data is transferred back from the other storage location to the original storage location (that is, the source storage location), the anonymized classification information is reverted back to the non-anonymized state.

For example, information for identifying the source storage location is associated with the data, and the source storage location is specified on the basis of the information. The information for identifying the source storage location includes information for identifying the device in which the source storage location is formed (such as a name of the device, a MAC address, an IP address, or a product number) and information for identifying the folder (such as the name of the folder), for example.

In the case where anonymization is achieved by removing some or all of the classification information, the removed information is reverted to the original state. In other words, the removed information is included in the classification information. The classification information including the previously removed information is associated with the data.

In the case where anonymization is achieved by encrypting some or all of the classification information, the encrypted information is decrypted, and the classification information including the decrypted information is associated with the data.

FIG. 9 will be referenced to describe Example 3 in detail. FIG. 9 illustrates the server 10 and the terminal devices 12A and 12B. As described in Example 1, the data 34 has already been transmitted from the terminal device 12A to the server 10 and the terminal device 12B, and the classification information 36B in the anonymized state has been associated with the data 34, attached to the data 34, and transmitted to the server 10 and the terminal device 12B. Information for identifying the source storage location is associated with the data 34. For example, in the case where the data 34 is stored in the folder 32A of the terminal device 12A, the source storage location is the folder 32A of the terminal device 12A. When the data 34 is transmitted from the terminal device 12A to the server 10 and the terminal device 12B, the information for identifying the folder 32A of the terminal device 12A is associated with the data 34 as information for identifying the source storage location, and the data 34 is transmitted from the terminal device 12A to the server 10 and the terminal device 12B. For example, information such as the MAC address, IP address, or product number of the terminal device 12A is associated with the data 34 as the information for identifying the terminal device 12A, and information such as the name of the folder 32A is associated with the data 34 as the information for identifying the folder 32A.

In the case where the data 34 is transmitted from the server 10 to the source terminal device 12A, the processor 30 of the terminal device 12A reverts the classification information 36B associated with the transmitted data 34 to the non-anonymized classification information 36A. In FIG. 9, the term “Restore” indicates reverting the anonymized classification information to the original non-anonymized state. The same applies to the case where the data 34 is transmitted from the terminal device 12B to the source terminal device 12A. Information for identifying the source storage location of the data 34 is associated with the data 34, and the terminal device 12A is specified as the source storage location on the basis of the information.

The processor 30 of the terminal device 12A may revert the classification information 36B associated with the data 34 to the classification information 36A when the data 34 is transmitted to the source terminal device 12A, or revert the classification information 36B associated with the data 34 to the classification information 36A when the data 34 is stored in the folder 32A of the terminal device 12A. The data 34 with the associated classification information 36A is stored in the source terminal device 12A.

The processor 30 of the terminal device 12A manages an anonymization history of the classification information 36A of the transferred data 34. For example, the way in which the classification information 36A was anonymized is managed as a history, and information indicating the history is stored in the memory 28 of the terminal device 12A. Specifically, information for identifying the data (such as the name, the creation date, the modification date, the creator, and the size of the data) and information indicating the content of the anonymization performed on the classification information associated with the data are associated with each piece of data, and the information is stored in the memory 28 of the terminal device 12A as information indicating the history of anonymization. By referencing the information indicating the history, the processor 30 of the terminal device 12A specifies the content of the anonymization performed on the classification information 36A of the data 34, and executes a restoration process corresponding to the specified content. Note that the information indicating the history may also be stored in the server 10 or another device.

For example, the processor 30 of the terminal device 12A generates the non-anonymized classification information 36A by adding the information that was removed from the classification information 36A when transmitting the data 34 to the server 10 or the terminal device 12B to the anonymized classification information 36B, and associates the classification information 36A to the data 34. Note that the removed information may be stored in the memory 28 of the terminal device 12A or in a memory of another device other than the terminal device 12A. The processor 30 of the terminal device 12A generates the non-anonymized classification information 36A by adding the information stored in the memory to the classification information 36B.

In the case where some or all of the classification information 36A is encrypted when transmitting the data 34 to the server 10 or the terminal device 12B, the processor 30 of the terminal device 12A generates the non-anonymized classification information 36A by decrypting the encrypted information, and associates the classification information 36A with the data 34.

Note the server 10 or the terminal device 12B may also restore the classification information.

In the case where the data 34 is transmitted from the server 10 to the terminal device 12B, the classification information 36B associated with the data 34 is not restored, and the non-anonymized classification information 36A is not generated. This is because the terminal device 12B is not the source device of the data 34. In this case, the anonymized classification information 36B is associated with the data 34, and the data 34 and the classification information 36B are transmitted from the server 10 to the terminal device 12B.

When the user who created data transfers the data from the destination storage location to the source storage location, the anonymized classification information is reverted to the non-anonymized state, but when another user other than the user who created the data transfers the data from the destination storage location to the source storage location, the anonymized classification information does not have to be reverted to the non-anonymized state.

For example, the data 34 is data created by the user A. When the user transfers the data 34 from the server 10 or the terminal device 12B to the terminal device 12A, the processor 30 of the terminal device 12A reverts the classification information 36B to the original classification information 36A, and associates the classification information 36A with the data 34.

Specifically, when the user A uses his or her own account information to log in to the terminal device 12A and transfer the data 34 from the server 10 or the terminal device 12B to the terminal device 12A, the processor 30 of the terminal device 12A reverts the classification information 36B to the original classification information 36A.

When another user other than the user A transfers the data 34 from the server 10 or the terminal device 12B to the terminal device 12A, the processor 30 of the terminal device 12A does not revert the classification information 36B to the original classification information 36A. For example, when another user other than the user A logs in to the terminal device 12A, the processor 30 of the terminal device 12A does not revert the classification information 36B to the original classification information 36A. In this case, the classification information 36B remains associated with the data 34.

Note that in the case where the data 34 is edited, the edited data is treated as different data from the unedited data 34. In this case, classification information is also associated with the edited data. In the case where the classification information 36A is associated with the unedited data 34, the classification information associated with the edited data includes the classification information 36A and information related to the editing (for example, information indicating the name of the editing user, the date and time of the editing, and the like). In the case where the classification information 36B is associated with the unedited data 34, the classification information associated with the edited data includes the classification information 36B and the information related to the editing.

In the case where the data 34 with associated classification information 36A is edited, the classification information 36A may be anonymized and the classification information 36B may be associated with the edited data. The classification information 36A may not be anonymized in the case where the data 34 is edited by the user A who is the creator of the data 34, and the classification information 36A may be anonymized in the case where the data 34 is edited by another user other than the user A.

### Example 4

In Example 4, the inclusion of specific information in the classification information is prohibited.

For example, the processor 30 of the terminal device 12A prohibits the inclusion of specific information in the classification information 36A associated with the data 34. The specific information is predetermined information, such as information which could be used to specify the creator of the data 34 (for example, information for identifying the creator, such as the name and gender of the creator) or information which could be used to specify the content of the data 34 (for example, information indicating the genre or field).

The inclusion of such information may be prohibited by the processor 20 of the server 10 or by the device treated as the destination of the data 34. For example, in the case of transmitting the data 34 to the server 10, the processor 20 of the server 10 prohibits the inclusion of the specific information in the classification information 36A. In the case of transmitting the data 34 to the terminal device 12B, the processor 30 of the terminal device 12B prohibits the inclusion of the specific information in the classification information 36A. For example, after the data 34 is posted to an SNS by the user A, the processor 20 of the server 10 may prohibit the inclusion of the specific information in the classification information 36A. Note that in the case where the classification information 36A is anonymized when the data 34 is transmitted to the server 10 or the terminal device 12B, and the classification information 36B is associated with the data 34, the inclusion of the specific information in the classification information 36B is prohibited.

For example, the specific information is not added to the classification information, even if the user gives an instruction to add the specific information to the classification information for which the inclusion of the specific information is prohibited.

The processor 30 of the terminal device 12A may also prohibit another user other than the user A who created the data 34 from including the specific information into the classification information 36A, but allow the user A who created the data 34 to include the specific information into the classification information 36A. For example, in the case where the user A uses his or her own account information to log in to the terminal device 12A, and gives an instruction to add the specific information to the classification information 36A, the processor 30 of the terminal device 12A obeys the instruction and adds the specific information designated by the user A to the classification information 36A. If a user other than the user gives the same instruction, the processor 30 of the terminal device 12A does not add the designated specific information to the classification information 36A. The above processes may be performed by the processor 20 of the server 10 or by the device treated as the destination of the data 34.

Additionally, the inclusion of the specific information in the classification information 36A or the classification information 36B may also be prohibited when another user other than the user A transfers the data 34 to another storage location. For example, in the case where the user A posts the data 34 to an SNS, and the user B reposts the data 34 to an SNS, the inclusion of the specific information in the classification information 36B associated with the data 34 is prohibited. The inclusion of the specific information may be prohibited by the processor 20 of the server 10 or by the processor 30 of the terminal device 12B.

Note that the editing of the classification information 36A or 36B by another user other than the user A may also be prohibited. For example, in the case where the user A posts the data 34 to an SNS, the user B is prohibited from editing the classification information (for example, the classification information 36A or the classification information 36B) associated with the posted data 34. For example, adding new information to the classification information and removing information included in the classification information are prohibited. The user A may be allowed to edit the classification information 36A or 36B.

The function of each unit in the server 10 and the terminal devices 12 above is realized by the cooperative action of hardware and software as an example. For example, the functions of each device are achieved by causing a processor in each device to load and execute a program stored in a memory of each device. The program is stored in the memory through a recording medium such as a CD or DVD, or alternatively through a communication channel such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
anonymize classification information associated with data and used to classify the data in a case where the data is transferred to another storage location.

2. The information processing device according to claim 1, wherein
the other storage location is a storage location accessible by a plurality of users.

3. The information processing device according to claim 1, wherein
the other storage location is a storage location formed in a different device than a device where the data is stored.

4. The information processing device according to claim 1, wherein
the processor is configured to:
not anonymize the classification information in a case where the data is transferred from a personal storage location used by a user to a different personal storage location used by the user.

5. The information processing device according to claim 1, wherein
in a case where the data is transferred from the other storage location to an original storage location, the processor is further configured to revert the anonymized classification information to a non-anonymized state.

6. The information processing device according to claim 2, wherein
in a case where the data is transferred from the other storage location to an original storage location, the processor is further configured to revert the anonymized classification information to a non-anonymized state.

7. The information processing device according to claim 3, wherein
in a case where the data is transferred from the other storage location to an original storage location, the processor is further configured to revert the anonymized classification information to a non-anonymized state.

8. The information processing device according to claim 4, wherein
in a case where the data is transferred from the other storage location to an original storage location, the processor is further configured to revert the anonymized classification information to a non-anonymized state.

9. The information processing device according to claim 5, wherein
in a case where a user who created the data transfers the data from the other storage location to the original storage location, the processor is configured to revert the anonymized classification information to a non-anonymized state.

10. The information processing device according to claim 6, wherein
in a case where a user who created the data transfers the data from the other storage location to the original storage location, the processor is configured to revert the anonymized classification information to a non-anonymized state.

11. The information processing device according to claim 7, wherein
in a case where a user who created the data transfers the data from the other storage location to the original storage location, the processor is configured to revert the anonymized classification information to a non-anonymized state.

12. The information processing device according to claim 1, wherein
the anonymization is achieved by removing some or all of the classification information.

13. The information processing device according to claim 2, wherein
the anonymization is achieved by removing some or all of the classification information.

14. The information processing device according to claim 1, wherein
the anonymization is achieved by encrypting some or all of the classification information.

15. The information processing device according to claim 1, wherein
the anonymization is achieved by replacing some or all of the classification information with different information.

16. The information processing device according to claim 1, wherein
an inclusion of specific information in the classification information is prohibited.

17. The information processing device according to claim 16, wherein
the inclusion of the specific information in the classification information by another user other than a user who created the data is prohibited.

18. The information processing device according to claim 17, wherein
in a case where the other user transfers the data to another storage location, an inclusion of specific information in the classification information is prohibited.

19. An information processing method comprising:
anonymizing classification information associated with data and used to classify the data in a case where the data is transferred to another storage location.

20. A non-transitory computer readable medium storing a program causing a computer to execute a process for processing information, the process comprising:
anonymizing classification information associated with data and used to classify the data in a case where the data is transferred to another storage location.
